(19) United States
(12) Patent Application Publication
(10) Pub. No.: US 2007/0096909 A1
(43) Pub. Date: May 3, 2007

(54) Interactive networking device

(76) Inventor: Matthew Lally, Fort Lauderdale, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/446,904

(22) Filed: Jun. 5, 2006

Related U.S. Application Data
(60) Provisional application No. 60/731,047, filed on Oct. 28, 2005.

(51) Int. Cl. G08B 13/14; G06F 17/00; G08B 19/00; G08B 21/00

(52) U.S. Cl. 340/572.1; 340/521; 235/375; 340/540

(57) ABSTRACT

A device and method allowing users to “wear” information that is readable and read the information “worn” by others. The device is a system using a tag and reader device similar to that used in RFID for inventory, etc. The reader acquires the identity of the tag and directs a browser or other software device to visit the web page of the person wearing the tag. From this web page, the visitor may download scripts relevant to displaying the tag-wearer's information in an appropriate manner. Combinations of the device with other devices such as media players, cameras, augmented reality systems, etc. are also described.

### CROSS-REFERENCE TO RELATED APPLICATION

This application is related to and claims priority to U.S. Provisional Patent Application Ser. No. 60/731,047, filed Oct. 28, 2005, entitled “Networking Device Allowing Users to Integrate the Online Experience with Everyday Social, Business and Other Interactions, Including “Wearing” Information Intended to be Read by Devices,” the entirety of which is incorporated herein by reference.

### STATEMENT REGARDING FEDERALLY SPONSORED RESEARCH OR DEVELOPMENT

n/a

### FIELD OF THE INVENTION

The present invention generally relates to social, business and other interactions, both on the Internet and in other situations, and more particularly to a method for and devices capable of providing a link between the online and offline world.

### BACKGROUND OF THE INVENTION

In the early 1990s, a product called the “:CueCat” was released and widely promoted as an easy way for users to access the web pages of products in which they were interested. The :CueCat was a barcode scanner that could be connected to a computer. Companies were encouraged to obtain :CueCat identification barcodes. These barcodes were to be placed in magazines, catalogues, on product packaging, etc. When a user developed an interest in a product, he or she could simply swipe the barcode scanner over the barcode and the software provided with the :CueCat scanner would send the user to the appropriate web page based on the barcode.

The :CueCat scanner used barcodes to deliver the visitor to a particular web page. However, it is a very simple process to copy a URL (web address) manually into the navigation bar of a browser. Everyday owners of websites were unlikely to go to the trouble of registering with :CueCat and carrying a barcode with them in order to identify their websites. A barcode does not have much appeal as a method of self-identification. If a person wished to visit the website of another person, it would be a much easier process to ask them their URL instead.

A better method of identification is RFID (Radio Frequency Identification). RFID is a system consisting of two devices: a scanner and a tag. A scanner emits a signal that acts as a request for identification. The RFID tag responds to the request by identifying itself. Both the request and response may or may not be encrypted for security or other purposes. The scanner collects the data and software may be used to translate the identification signal into meaningful information, such as product identity or other information.

Previously, RFID tags have been used to track merchandise for purposes of keeping inventory in merchants such as Wal-Mart. They have been used as implants in cybernetics experiments in humans and in tagging pets and other animals for the purposes of tracking or identification of the animal implanted. They have also been used as non-implanted tags for similar purposes with wild animals and felons. To my knowledge, they have never been used to identify the websites or other online attributes of tagged persons.

Currently there are several patents and published patent applications describing art that makes use of RFID technology. For example, U.S. Pat Nos. 6,691,914 B2 and 6,871,780 B2 describe methods of utilizing codes such as bar codes, RFID data, etc. to access websites. It specifically deals with transfer of data from one site-initially accessed using the codes to a second site, including country, language, service type required, media-type required and access certificate. In these patents, no discussion is made regarding social networking applications of the invention.

U.S. Pat. No. 6,793,127 B2, US patent application US 2002/0170952 A1, and international patent application WO02/082363 A1 describe a method of using data on RFID or other tags to adjust the parameters of devices such as washing machines, including a method whereby tags identify a location from which the device is made to download instructions in the form of an XML or other document. The patent does not disclose any method of adjusting the parameters of a device using directional reading of tags, nor does it disclose any method of adjusting the parameters of personal media recording or playing devices or use of said media devices for social networking.

US patent application US 2002/0078363 A1 describes a portable, handheld device for scanning items in a store with RFID, IR or other scanning technology including an IR scanner with a lens. The device has the ability to communicate with the internet. The purpose of the device is to scan items and compare prices and other information with that from online vendors. The patent application does not disclose a method of using the device for social networking.

US patent application, US 2005/0229227 A1 describes a method of recording the location of objects located within a TV studio and using this location data for advertising. RFID tags are used as beacons to mark the corners of a cube, against which other objects in the studio are referenced. RFID tags are put in clothes, sofas and other miscellaneous items. Triangulation of RFID tags is done using a reader capable of performing this action. The location of the items with tags is recorded and associated with the actual video footage recorded for broadcast. In this way, data about objects on-screen can be used to provide appropriate advertising and purchasing options to the viewer. The description in the patent was for a studio recording situation and no method of synchronizing location and image data was provided for a portable device. In addition, the patent recommends the use of triangulation to locate the tags. Devices capable of triangulation of RFID tags to find their location are typically large and not suited for incorporation into portable devices. Further, the patent does not discuss social networking applications.

US patent application, US 2005/0212676 A1 describes a device that indicates the location of tags by illuminating tags or tagged objects using a laser or other beam. The location of the tags is determined either using a radio beam limited to certain directions or by triangulation using RFID scanners in different locations. It discusses a method of providing directionality to the beam using a directional receiving antenna or transmitter or by limiting emission of the RFID beam using conductive or RF-absorptive material. The location of tags is indicated by a visible beam using either a laser or other highly focused beam that points at the location determined by triangulation or by aligning the visible beam path with the beam path of the RFID beam. Typically, the precision in locating a device using RFID alone is not sufficient for distinguishing between persons in close proximity to one another unless a large device is used. This patent makes no discussion of social networking applications of the device disclosed.

U.S. Pat. No. 5,874,724 describes an RFID tag that can be activated by a specific pattern of flashing light or specific wavelength of light. The directional beam of flashing light can activate the tag and then an RFID device will be able to interrogate the tag. The use of helper-beams is also described. No mechanism is described whereby multiple ID readers can be made to work in the same area without interference and still obtaining data regarding the location of tags. In addition, no method of using the device described for social networking purposes is disclosed.

Bluetooth phones exist that allow users to identify other nearby users. These phones can be expensive, do not easily allow users to visit each other's websites and do not allow users to really identify the person they are identifying as a fellow Bluetooth phone owner. Bluetooth phones have been used in social settings, such as bars, whereby users can determine who is nearby. It is possible to view profiles of nearby users. However, there is no function available that would allow a user to find out information about a specific person in whom they are interested without searching through the various profiles of users in the vicinity. Additionally, no method is available that would allow users to modify their appearance to others, and hence the possibility of “wearing” appealing data is limited.

Augmented Reality systems (often interchangeably known as Mediated Reality systems), such as that created by Steve Mann of MIT allow filtering and addition or alteration of information before it enters the sensory organs and brain. The examples I have read about use screens on eyeglasses or lasers to project images onto the user's retina. They may use earphones to allow sound into the ear of the user. A camera may be mounted on the eyeglasses or elsewhere in order to record the external world, and then pass this information through a CPU before allowing it into the eye or ear via the devices mentioned earlier. Effects such as replacing advertising with browser windows, picturesque scenes, etc have been achieved. Users have been able to receive email, browse the Internet and instant message others using the augmented reality interface. To my knowledge, no provisions have been made that would allow other people to indicate how they would prefer to be viewed by such a system or to provide information that they would like the user of such a system to be able to access.

MySpace, Yahoo! 360, and other sites available on the Internet encourage users to interact with each other socially. Users regularly post personal blogs, their favorite music, and other information about themselves for the whole world to see. Alternatively, users may limit who sees their site to friends, friends of friends, etc. Users can seek other users with similar interests and befriend them. It seems that users occasionally meet on MySpace and similar sites and then arrange to meet later on in person. However, while users can certainly reverse the process by meeting in person and exchanging URLs or other information that can be used to locate their web page, it seems there is no simple way for users to “advertise” their URL. Many of the users of MySpace and other such sites would no doubt be highly inclined to advertise their URLs to the world. They are often very young and display their affiliations with pride, including fashions, music, favorite actors, favorite TV shows, etc. MySpace and similar websites provide a forum for them to display these affiliations online, but there is no link currently available between their offline presence and their online presence.

Accordingly, several objects and advantages of the invention follow. The device described by this patent allows the holder of an RFID, infra-red or other identifying tag to easily provide users of a device incorporating an appropriate scanner, including RFID, IR, Bluetooth, etc. with a web or other address from which other information can be obtained. This invention allows holders of the appropriate tags to “wear” this information as if it were an item of clothing that can be seen by anyone with the appropriate scanning equipment or device incorporating such equipment.

The device includes a tag that users will wear wherever they wish the information contained within it to be available. This is similar to any item of fashion. For example, a person may wear a Roc-a-Wear logo on their clothes to indicate that he or she is a member of hip-hop culture, that he or she appreciates the music associated with that brand, or simply that he or she appreciates the style of the logo or clothing itself. Providing information to others using an RFID or other tag is similar to wearing a logo on your clothes. It allows people to casually glance at you and see information that you wish to present to them. The clothing that a person wears projects an image of them to onlookers. The tag as described in this device is an extension of clothing fashion that allows users to transmit more information than ever before to onlookers.

Of course, it is not only the young and fashion-conscious who wish to present an image of themselves to the world. Businesspersons wear suits or other smart clothing to present themselves as professionals. It would be a significant improvement if they were able to provide their resume, contact information, as well as a professionally designed website along with this information. This application would be especially useful in situations such as conferences where one of the main purposes for attendees is often networking. Such a device would make networking far more efficient for busy people.

Makers of brand products such as NIKE® put professionally designed logos on their products in order to make the wearer advertise for them. If they could provide additional information to onlookers via their website, including purchasing ability, this would be useful to them. The tag described in this patent would do exactly these things for many kinds of users, and the scanners used to request and translate the identity information from the tag could be incorporated into many different kinds of devices for daily use.

The nature of the method of transmission of information used by the device described herein is a significant improvement over the method of barcodes that was used in the :CueCat device. Barcodes are often difficult to read by scanners designed exactly for that purpose. With the exception of certain people who have barcodes tattooed on their bodies or on their T-shirts, few people would willingly carry a barcode with them. This limits the use of barcodes for social transmission of information to a select few people, if any. Further limiting this method of information transmission is the requirement that other members of the public carry with them a barcode scanner. According to marketing experts such as Seth Godin, ideas become less likely to spread well if you add steps that are uncomfortable or difficult for the users who are expected to spread them. People who wear the images of fashion logos or music artists on their clothes do so because it spreads the message that they are on the cutting edge of fashion or music without difficulty. Spreading the same message by exchanging barcodes would be much more difficult. It would be impossible for interested passer-bys to quickly obtain any information. The information could only be exchanged by passing a card with the barcode or something similar.

The advantage of using RFID, infra-red or other long-range scanners and tags instead of barcodes and barcode scanners to transmit information from person to person should be clear by comparison. RFID and other tags are able to indiscriminately transmit information when requested in the appropriate fashion. This is exactly the kind of transmission of information desired by wearers of fashion items. It is also the kind of transmission desired by wearers of business apparel and by makers of brand shoes, clothing, etc. Using encryption of the tags would make it possible to limit whoever is able to view the fashion information to those who own a particular brand of device.

Current uses of RFID tags do not include transmission of fashion information. This is a huge advantage provided by the device described herein. Specifically, the device described herein allows owners of the scanning device to obtain information provided by the owner or manufacturer of a tag including information in the form of various file types that can be downloaded from the internet via wireless or other forms of internet connection. While users of RFID tags do maintain databases correlating identity information provided by the tag to other information, including websites, the majority of prior art is directed at inventory control and providing new means for the customer to purchase commercial items. Since normal RFID devices are non-directional, most those devices described in the prior art do not disclose methods of reading the ID of one specific RFID or other electronic tag from a significant distance. Where devices have accomplished this task, no provision is made for operating the device in the presence of other readers without confusing which reader is scanning which tag. Typically, directional reading of tag data is done using barcodes. The device described herein allows the owner of the tag to send the visitor who is scanning his or her tag to a website to learn more about him or her-be it personal tastes, business information, company information in the case of tags imbedded in or attached to clothing or other commercial or non-commercial products. It is the belief of the author that this difference could allow this technology to become extremely popular among several different kinds of users.

Bluetooth phones do allow exchange of information between users, but the device described herein accomplishes several things that these phones do not. Firstly, the nature of RFID and other tags capable of achieving a similar result means that they can be very cheaply produced and sold. This would make is very easy for everyday people of a range of economic means to purchase these devices. It is possible that they could be manufactured cheaply enough that they could be given away in order to create a larger base of early adopters. The scanners could be sold separately or with tags included and because of the widespread use of the tags, they would be usable immediately, as opposed to Bluetooth phones, which are generally expensive. In order for them to be used, other phone users need to be using suitable phones. As described in this disclosure, scanners could be set up in areas like malls, nightclubs, and other public venues that would allow owners of these cheaply produced tags to see the results of tag-ownership immediately. Other services could be associated with tag-ownership, such as identification for other purposes, thus further increasing the use of such tags. Obviously security would be a much more important consideration if some of these services required high security.

A further advantage of the device described herein over Bluetooth mobile phones is that the scanner could be made into a directional device. To my knowledge, Bluetooth phones are not equipped with this capability. Directionality of the scanner allows users to be more specific about whom they are interested in learning about. Further details on methods for accomplishing directionality are described elsewhere in this disclosure.

Augmented reality systems are currently the domain of early adopters and researchers. They are certainly not in widespread use. To my knowledge at date of writing, none are commercially available. I am not aware of any method for accomplishing the kind of information transfer I have described elsewhere in this disclosure using augmented reality technology, however. When this technology does become commercially available, it would be appealing to users if owners of tags could alter their appearance to users of augmented reality technology by embedding scripts on their web page and linking to their web page via a tag as described in this disclosure. Appearance, as used here refers to the idea that owners of tags or third-parties could create scripts that cause the owner of augmented reality technology to perceive them in a different way to that in which they would normally. For example, tag owners could program special effects like stars, symbols or logos flying around or near to his or her body, glasses or a mask on his or her face. The special effects applied could include complete alteration of the tag-users appearance. Special effects could be made to correspond with body movements, gestures, or other signals in combination with tag instructions. Alternatively, the effect could be as simple as the appearance of their web page or an automatic download of certain music. A soundtrack could play whenever people see the tag owner. Obviously this would all be dependent on permission setting by the owner of the augmented reality technology set.

Since augmented reality technology is not yet commercially available, this invention could be applied to digital cameras. Cameras with Wi-Fi wireless internet connections are currently being developed. By incorporating a directional scanner to obtain ID data for the objects or people being photographed by such a camera and by providing appropriate hardware and software within the camera to perform such a task, a camera could be made to associate data such as websites, links to websites, music, special effects, additional images, text, as well as other forms of data with the images of objects that were photographed by the camera. One simple alternative way in which text may be associated with an image is by naming the image and saving it by said name. When the camera is activated to take a photograph of an object, the scanner incorporated with said camera would also be activated and so the image and RFID or other tag data could be collected together. The tag data could then be used to obtain further instruction from the internet by downloading scripts, files, etc. A natural extension of this description is the use of this invention with video cameras and cameras incorporated into mobile phones and other devices.

The device could be used to send the visitor to sites such as MySpace or to sites hosted on another website. Alternatively, it could send all visitors through an intermediate site that forwards visitors to the site desired by the tag owner. Password-protection could be used on this site if desired. Tag owners could set up their preferences so that only certain types of visitors can access certain files or objects.

Many users of the internet “surf” the internet using simple browsers, but some use browsers capable of operating plug-in software, sometimes developed by third parties. Examples of plug-in software for web-browsers include toolbars, options to view or leave virtual “tags” and “notes” left by or to be viewed by other viewers. Many other options are available. Of course, such plug-in software might become available for the device described herein in order to increase the functionality of the device and usefulness to the user. One example might be a piece of software that allows users to leave and view virtual “tags” and “notes” on the webpage associated with the tag of a particular user, and by extension associate those tags and notes with the actual person. Many other examples are likely to become available. The device could be used as an independent product or as an add-on for another device such as an iPod, Playstation Portable, mobile telephone or other device, or could be incorporated directly into future versions of these kinds of products in order to enhance their functionality.

Further objects and advantages will become apparent from a consideration of the ensuing description and drawings.

### SUMMARY OF THE INVENTION

The present invention is a device that allows specific modes of transmission of information about the tagged person or article. It consists of a tag and tag reader connected to a device capable of accessing the Internet or other network system for further information. The tag responds to requests from the reader for identity information. The reader interprets this information to provide a URL or other information capable of locating another store of information. This store of information may be the web site associated with the tag. Through an integrated or attached browser, computer system, or other device capable of accessing the information store or Internet, the device accesses the information store or website. This website can then either forward the visitor's reader to another website or directly provide scripts, downloads, etc. The reader will then display or otherwise present the information received to the user through a suitable integrated device or other device configured to work with the device described herein.

Essentially, the device allows the wearer of the tag to effectively wear whatever information they desire. According to the preferences of the owner of the reading device, this information may be interpreted for the senses of the owner of the reading device in the form of music, movies, special effects, and any other form of display available.

According to an aspect of the invention, an interactive networking system is provided. The interactive networking system includes one or more readers able to communicate with a network, wherein the network includes information accessible at a network location, and one or more tags containing the network location of the information. Upon receipt of an interrogation signal from one of the one or more readers, a tag is able to communicate the network location to the interrogating reader thus making the information accessible to the interrogating reader.

According to another aspect of the invention, a method of conveying information from a first person or object to a second person is provided. The method includes providing a tag operated by the first person or object, wherein the tag includes information about the tag or about the first person. The method further includes providing a reader operated by the second person, wherein the reader is able to transmit communication signals to the tag, the communication signals including a request for the information. Upon receipt of the request for information, the information is communicated from the tag to the reader, and the reader access the information.

According to yet another aspect of the invention, a method of associating one or more images with information in a network is provided. The method includes identifying one or more images, identifying information relating to the one or more images, the information available on the network, and associating the information with the one or more images.

According to another aspect, a tag for use in an interactive networking system is provided, where the interactive networking system includes one or more readers in electronic communication with the tag. The tag includes means for receiving communication signals from a requesting reader, where the communication signals include a request to the tag for information related to the tag, and means for making the information accessible to the requesting reader.

DEFINITIONS: As used herein, the following terms are stated in accordance with the provided meanings:

“Host”: Person using an RFID, IR or other tag that provides information to the visitor.

“Visitor”: Person using a reader, including transmitter and receiver, that requests identification from hosts with RFID, IR or other tags.

“Directional”: Preferring to detect or transmit in a beam-like manner. The cone of said beam will be referred to as “limited direction”.

“Omnidirectional”: Not preferring to detect or transmit in or from any particular direction.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a drawing showing how the transmitter (a part of the reader) can send a request with directionality;

FIG. 2 shows one suitable structure of a tag;

FIG. 3 is a drawing showing how the tag responds to the request by sending a signal in all directions;

FIG. 4 shows a how a receiver (part of reader) intercepts the response from a tag;

FIG. 5 illustrates the data transmitted between reader and tag in each direction;

FIG. 6 is an overall schematic describing the device and its components;

FIG. 7 is one preferred method of accessing a particular site using a hub site;

FIG. 8 shows how the transmitter (a part of the reader) sends a request to the tag without directionality;

FIG. 9 shows how the receiver (a part of the reader) can limit the directions from which it receives responses from tags;

FIG. 10 shows the use of multiple receivers, one omnidirectional and one directional;

FIG. 11 shows a planar array of transmitters for obtaining higher resolution location data from the device;

FIG. 12 shows a convex array of transmitters;

FIG. 13 shows a concave array of transmitters;

FIG. 14 shows a beam grid consisting of the footprints of beams emitter by the reader;

FIG. 15 shows the use of a lens to adjust the footprint of emitted beams;

FIG. 16 shows a ramification of the device featuring an incorporated camera;

FIG. 17 shows components of the device incorporating a camera;

FIG. 18 shows a flow chart describing the flow of information in the device;

FIG. 19 shows image-processing using the device, and a camera;

FIG. 20 shows image-processing using the device with an infra-red camera;

FIG. 21 shows incorporation of the device into an augmented reality system;

FIG. 22 shows the device as a peripheral for an additional device;

FIG. 23 shows how the device can be adapted to work well with a mobile phone, PDA or gaming device;

FIG. 24 is an additional method of using a hub site to access a desired website;

FIG. 25 is an additional method of using a hub site to access a desired website;

FIG. 26 is an additional method of using a hub site to access a desired website;

FIG. 27 describes the use of user preferences to modify the results of the device;

FIG. 28 shows the processes involved in use of the device with an infra-red camera;

FIG. 29 shows the processes involved in use of the device with an RFID or other triangulation device;

FIG. 30 shows the use of time-of-request data to modify the device for scanning with a single reader;

FIG. 31 shows one possible path of a scanning reader; and

FIG. 32 shows the processes involved in use of the device with a scanning reader.

### DETAILED DESCRIPTION OF THE INVENTION

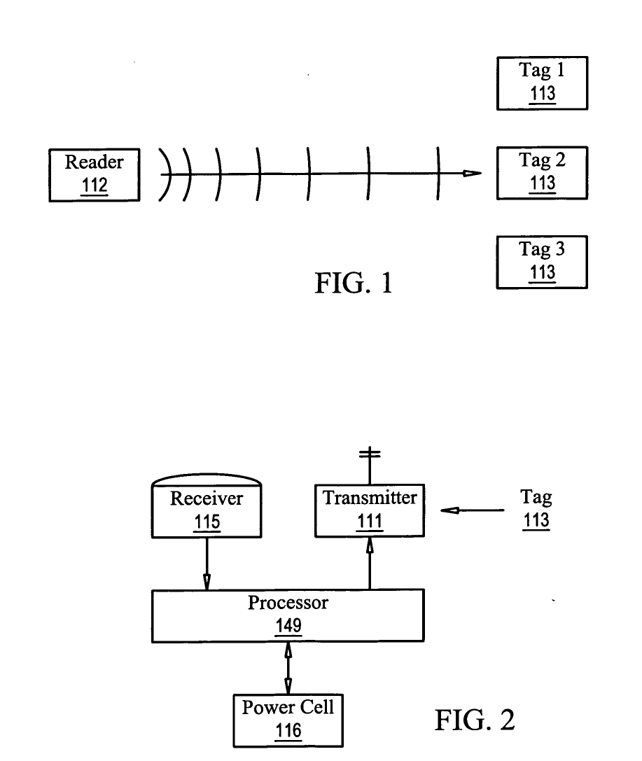

FIG. 1 shows a directional transmitter, part of a reader, 110. In FIG. 1, the interaction between the reader 112 and tag 113 is illustrated. The transmitter should preferably transmit an encrypted request for identification in one limited direction, similar to a beam of light from a torch. One method of transmitting a directionally limited beam is using an infra-red emitter. Alternatively, visible and ultra-violet radiation would be easily directed and limited. Some methods exist for creating limited, beam-like radio wave and microwave emissions, such as use of specific antennas and limiting the route of escape of radio waves using conductive or absorbing material. Masers, lasers and other highly directional methods of information transmission could also be used. In addition, sound waves can be made beam-like. Methods of transmission of information using these different types of waves and others are known to those skilled in the art and include frequency modulation, amplitude modulation and pulsing.

FIG. 2 is a schematic diagram describing the functions of the tag 113. Receiver 115 is a receiver, preferentially an infra-red receiver with no necessary preference for receiving signals from one particular direction, hence it is omnidirectional, although for practical purposes its directionality may be limited. Transmitter 111 is preferentially a radio antenna capable of transmitting over preferably large ranges such a several feet and greater. Processor, 149 is a program, processor, chip or other means that responds to the signals received at receiver 115, by sending a signal containing required identity and other information as required via transmitter, 111. Tag power cell 116 may store energy for use as required by other elements that comprise the tag.

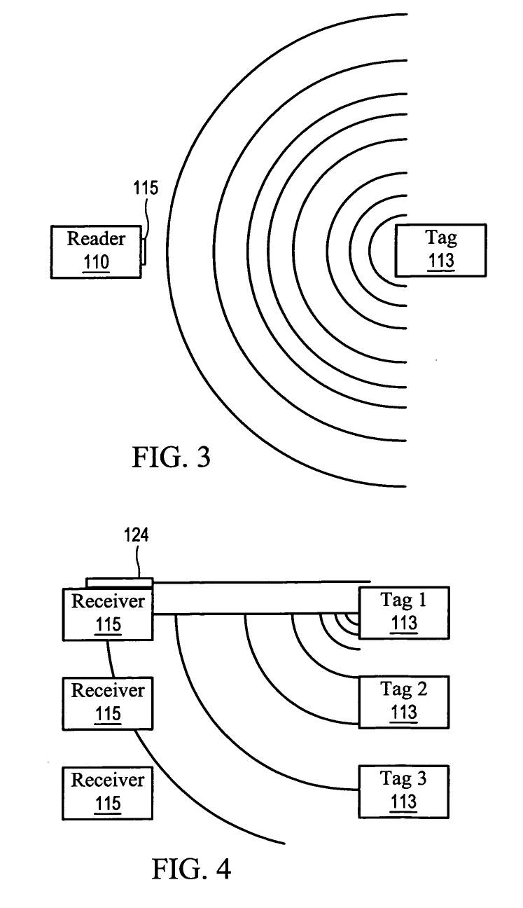

The tag responds to the encrypted request for identification per FIG. 3 by sending an encrypted RF signal in all directions, although the actual directionality may be limited by practicalities. A receiver 115 is attached to the transmitter to receive the signal from the tag, per FIG. 4. In FIG. 4, part 124 is a sighting system such as a colored laser or LED that indicates from which direction the transmitter is soliciting responses.

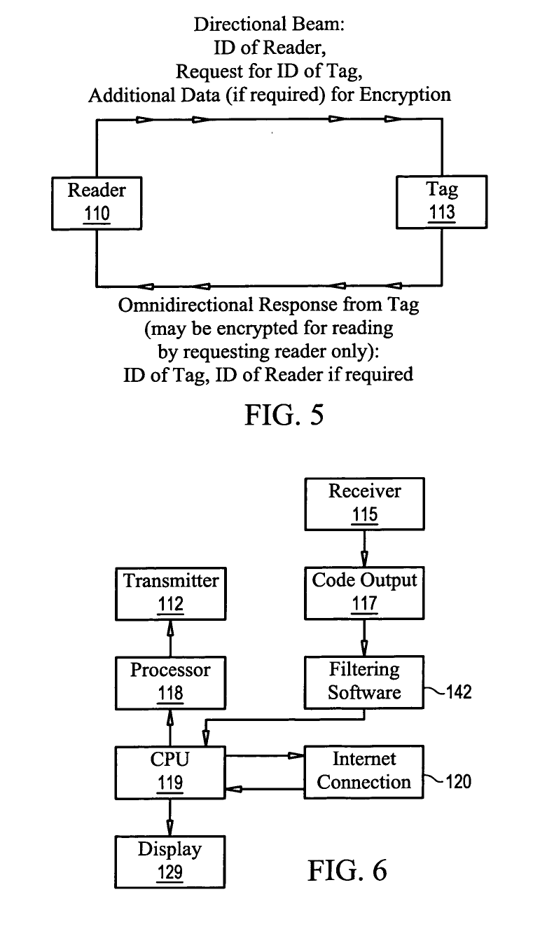

In FIG. 5, the information sent from the reader 110 to the tag 113, includes information required to solicit a response from the tag, such as a password set by the manufacturer, a request for identification, which may be represented by the aforementioned password, and identification of the reader. The tag 113 responds by transmitting a preferably encrypted message containing the identification of the tag and preferably the identification of the requesting reader.

In FIG. 6, receiver 115 is attached to a processor 117 that translates the signal from the receiver into a data series, or code output that is received by the filtering software 142, attached. The filtering software 142, removes codes generated by signals that do not contain, for example, the correct identification of the reader and sends codes that do contain the correct reader identification to the CPU. In one embodiment, processor 117, and filtering software 142 may be software programs that are incorporated into the software installed on the CPU 119. The CPU has an Internet connection 120, and has installed software that directs it to send the data series received from the filtering software to a website, the location of which is pre-programmed into the software. A display 129, is attached to display information. In the preferred embodiment, this would be an LCD or other contemporary display such as that used in portable video game and MP3 systems or digital cameras.

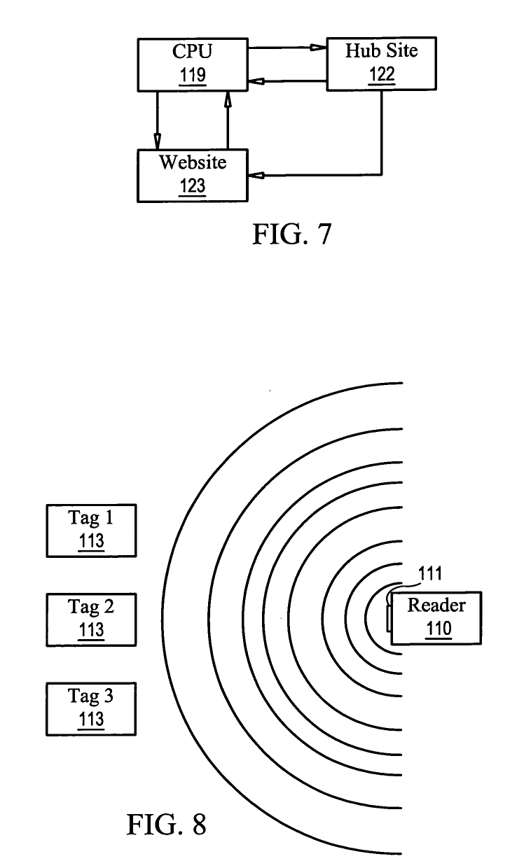

FIG. 7 shows a preferred embodiment of the internet connection 120. In this preferred embodiment, the CPU 119, connects to a first hub site 122, and transfers the code obtained from the tag to the hub site 122. The hub site 122 contains a database that may be accessed by tag-owners to change properties associated with the tag belonging to the tag-owner. Based on the code inputted by the CPU 119, the hub site then forwards the CPU 119, to a second website 123. This second website is then displayed on the display, 129.

Reader 110, is directed at another user or object in whom the visitor (using reader device) is interested. Sighting system 124 can assist the user in aiming the device at the particular person or object in whom he or she is interested. The visitor issues an instruction, via controls attached to the CPU 119. As a result, the processor 118, which may be a function of the software installed on CPU 119, sends an encrypted signal to the transmitter 112. The transmitter 112 sends a beam-like signal in one specific direction requesting identification from tags 113 within the path of the signal. The tag(s) 113, within the path receive and respond to the signal with an encrypted signal that is sent in all directions. The receiver 115, receives signals from tags regardless of whether they were activated by the attached reader and regardless of their location. The signal is then sent back to the code-output processor 117, which translates the received, and optionally encrypted signal into a series of digits-a code. The filtering software 142, then removes all codes that do not contain the identification associated with the attached reader 110, incorporating transmitter 112. In this way, it removes all codes sent by tags that were interrogated by readers other than the attached. The remaining codes, intended for use by the specific device are then sent to the CPU 119. The CPU 119, is then instructed by software to visit a website, the location of which is pre-programmed into the software. It does this using Internet connection, 120. The series of digits is entered into the website 122, which responds by sending instructions back to the CPU 119. These instructions will consist of either a web page, redirect to another website, or other script. The browser running on the CPU 119 will then represent the information it has gathered from the exchange via attached outputs and display 129.

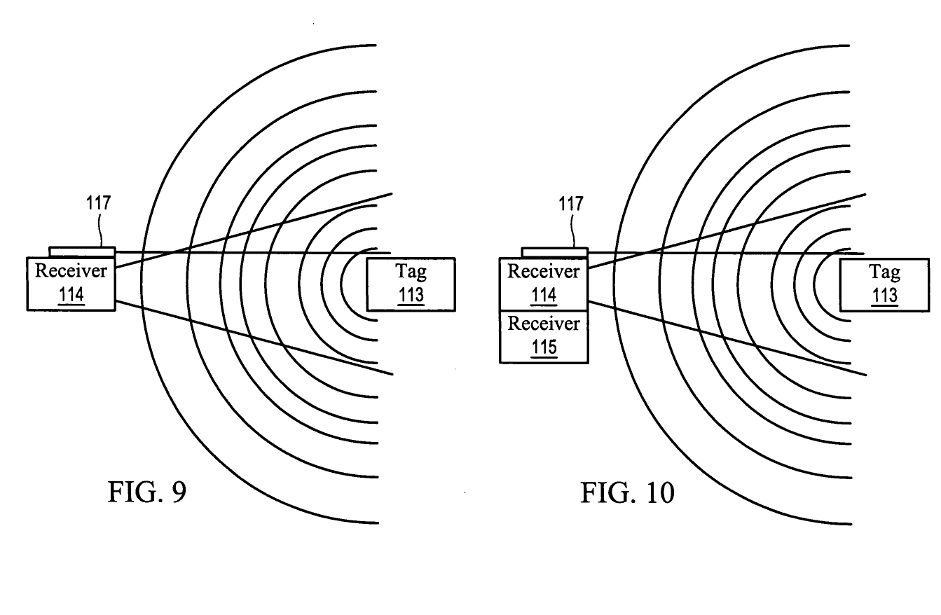

In a second embodiment, as illustrated in FIG. 8, reader 110 includes an omnidirectional transmitter 111 instead of a directional transmitter 112. As shown in FIG. 9, the receiver 114, is directional. In this embodiment, the omnidirectional transmitter 111, can be used to send a request for identification that is not limited to any particular direction. The receiver 114, however, is limited to receiving responses from tags 113 that are located in a particular direction. Thus, although nearby tags will be activated by the omnidirectional request for identification, the device will only detect the responses from tags in a particular direction.

In another embodiment shown in FIG. 10, the device may comprise an omnidirectional transmitter 111 (not shown) and two receivers; one directional receiver 114 and one omnidirectional receiver 115. The addition of an omnidirectional receiver 115 with detection in all directions to the first, directional receiver, 114 with detection in a limited direction, provides extra information. For example, should a visitor wish to determine whether there is a tag nearby but not in the line-of-sight, an omnidirectional request for identification could be sent. The second receiver would detect and even list identities of nearby tags 113. The first receiver, being unidirectional, could then be used to determine exactly where the tag is located-i.e., where the host is.

In a further embodiment, both the transmitter 111, and the receiver 115 are omnidirectional. In this embodiment, the reader collects no directionality information. The only information recorded is what tags are nearby. In this case, the information downloaded from internet or network locations can be either displayed randomly, displayed in menu form for the user to browse, or collected for a database. Alternatively, the tag identities can be recorded and used as links to the internet that can be browsed by menu, immediately or later. These embodiments would be useful for clubs, malls, etc, who wish to know more about patrons or who wish to advertise the interests of their patrons without identifying patrons. In such an instance, proprietors of such businesses might be solely concerned with knowing who is in their establishment, not who is who. Additionally, nearby tags could be used to provide the network location of information that does not require directionality information. Examples of such information include music files that could be automatically downloaded or listed for later download when a tag indicating the network location of such a file is within range of the reader. Maps, itineraries, webpages and other documents could be downloaded when in range of a tag indicating the network location of such information. Additionally, information relating to objects such as artifacts in museums could be downloaded in a similar manner.

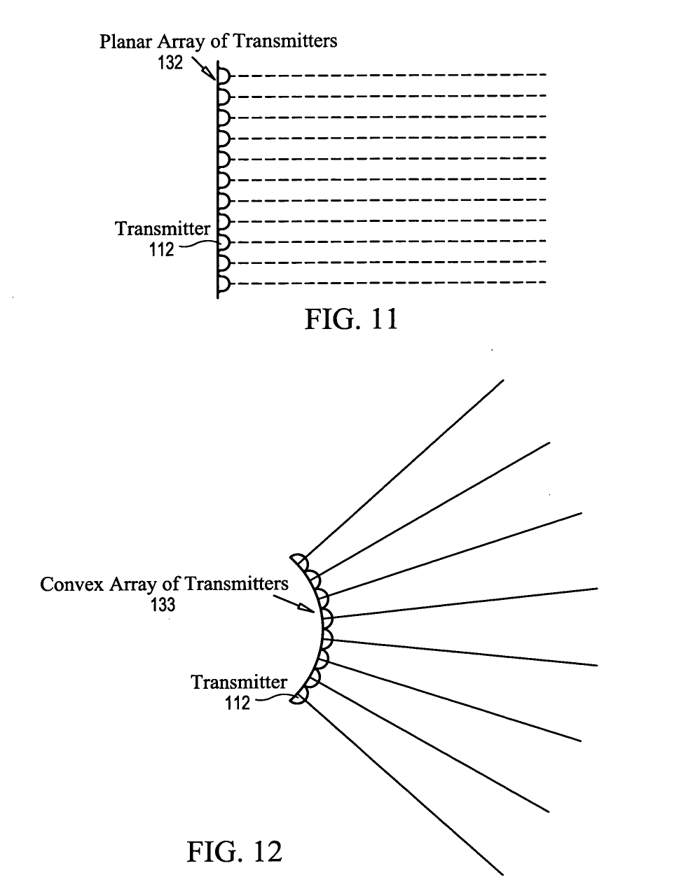

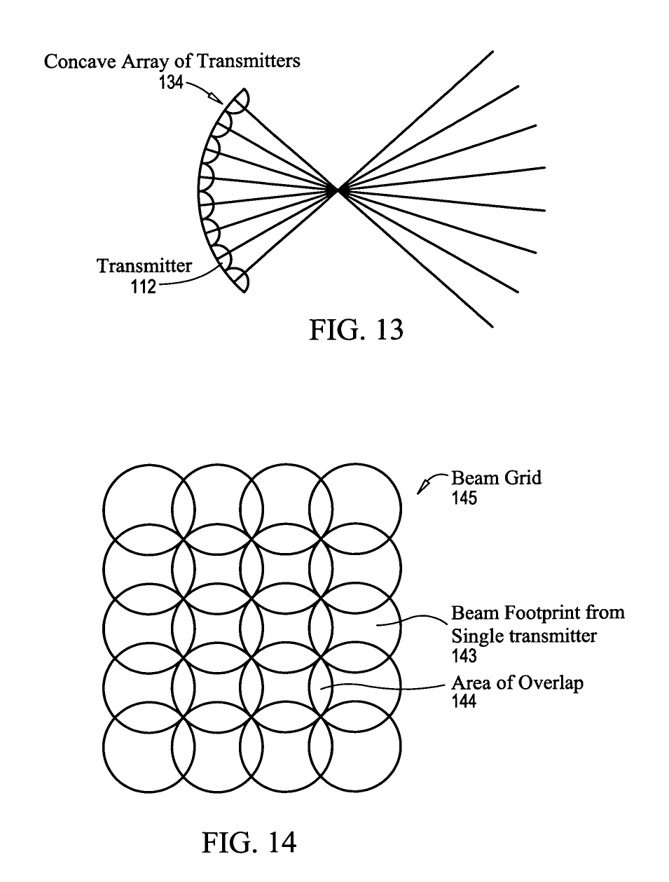

In still another embodiment, shown in FIG. 11, at least one or more transmitters 112 are arranged to form a planar array of transmitters, 132. FIGS. 12 and 13 show variations in shape of the array of transmitters. FIG. 12 shows a convex array of transmitters 133, and FIG. 13 shows a concave array of transmitters 134. As illustrated in each of the figures, and taking FIG. 11 as an example, the lines of site of each of the transmitters 112 should ideally be different, although the beams produced may each overlap to some degree. As illustrated by FIG. 14, the transmitters 112 should preferably be arranged in such a way that the footprints of beams emitted 143 on an object of interest overlap 144 just enough that there is no space left on an object of interest without illumination by the emitted beams. Although the beam footprints 143 illustrated in FIG. 14 are circular, any shape would work. Each of the transmitters 112 responsible for producing each beam footprint 143 is assigned a specific identity that distinguishes it from other transmitters 112. Each transmitter 112 may function independently of other transmitters 112.

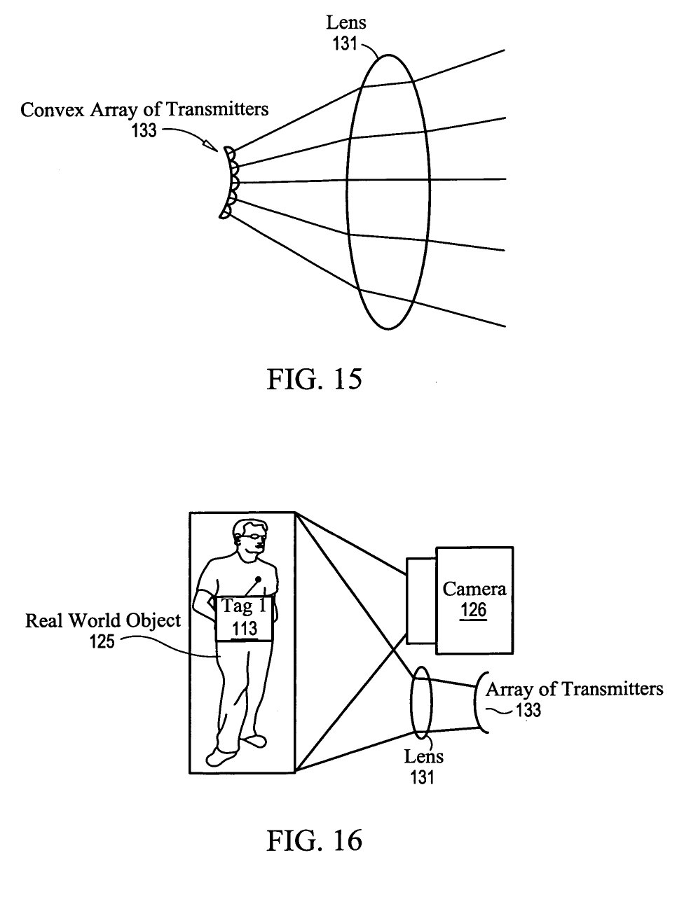

As illustrated in FIG. 15, the path of emitted beams from an array of transmitters, for example, convex array of transmitters 133 can be altered by the addition of a lens 131. FIG. 16 shows how an image-capture device or camera 126 can be included in the device for capturing the image of real world objects 125. The path of emitted beams from array of transmitters 133 can be altered with lens, 131 so that the entirety of real world object, and other objects that fall within the frame of the image to be captured is covered by at least one of the emitted beams.

As illustrated in FIG. 6, the processing software 117 provides codes to the filtering software 142, which then eliminates codes that are not identified as relevant to the reader in question. In the case of multiple transmitters 112, as members of an array of transmitters, such as the planar array of transmitters 132, in FIG. 11, several codes may come through at any given time, each associated with a different transmitter.

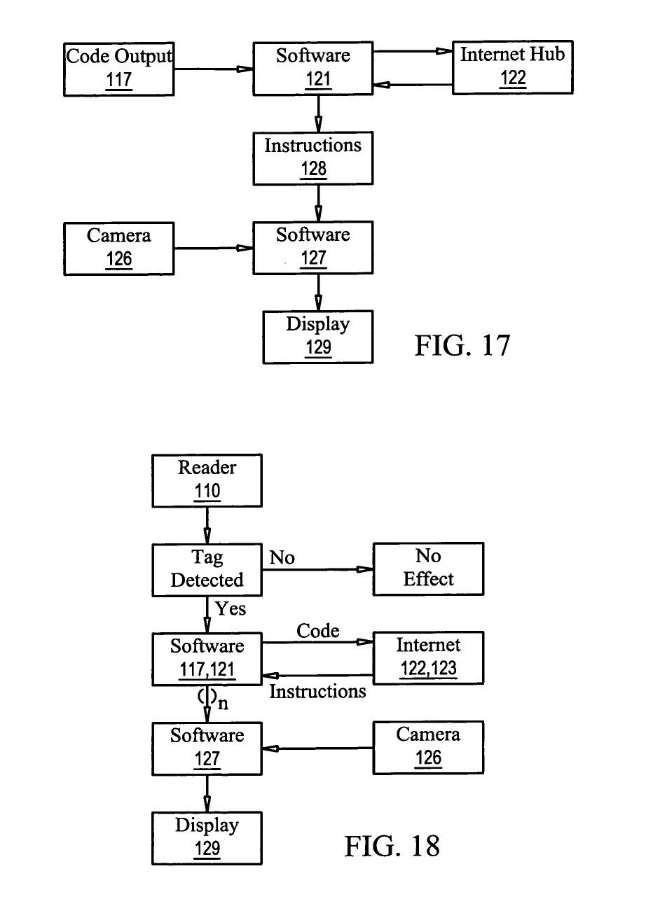

As shown in FIG. 17, the software for communicating with the website 121 is written in such a way that it can download instructions 128 from the internet, via internet hub 122 and transfer them, along with information about to which section of the recorded image they correspond, to an image-processing device 127 or equivalent element of software. As shown in FIG. 18, where an array of transmitters is used, multiple (n) sets of instructions 128 may be sent to the image processing software 127. Each of the sets of instructions 128 should be associated with or contain some information about where on the image to be processed they should be applied. A camera or other image-capture device 126 is attached or wirelessly connected in such a manner that it can transfer captured images to the image processing device 127 for processing. The image processing device 127 should preferably be able to perform operations on the captured images as indicated by received instructions 128.

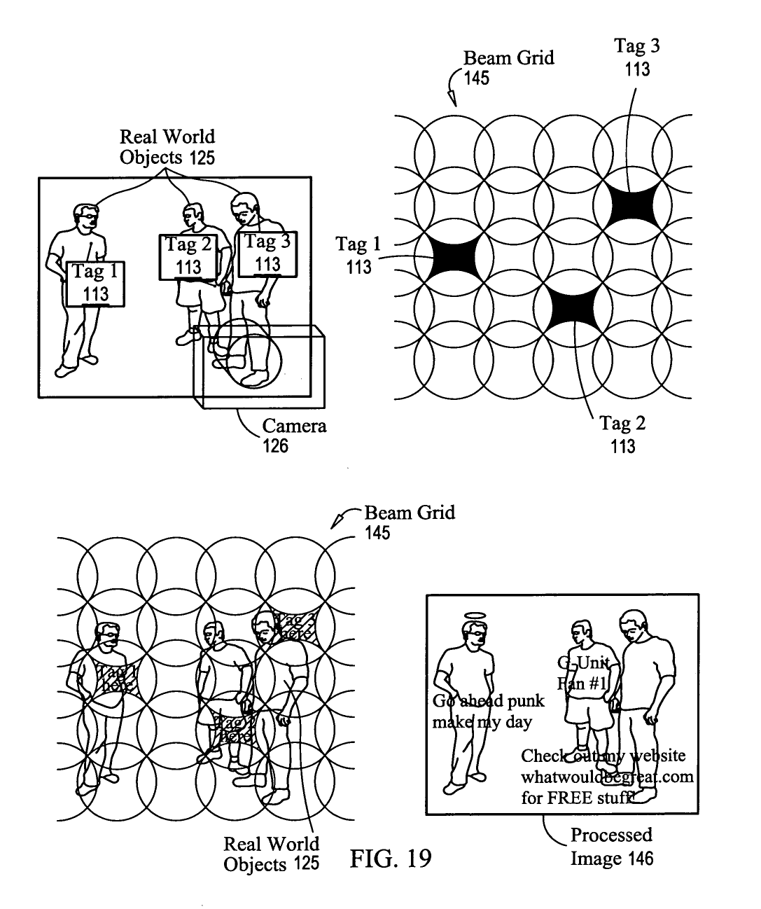

FIG. 19 illustrates the overall function of the device. Camera 126 is used to photograph real world objects 125. Beam grid 145 is projected onto the area to be photographed. Real world objects 125 have associated tags 113 that provide instructions for processing of the image per FIG. 18. Only certain of the beam footprints 143 fall on tags 113, and so only in these parts of the image or for objects recognized by image-processing software 127 that partially or completely fall into the section of the beam grid 145 in which a tag 113 is detected is processing performed. Processing depends on the instructions 128 provided by the tags 113. In the figures, the images of real world objects 125 are modified by the image-processing software 127 to produce processed images 146. The image may be annotated, altered, completely changed or partially changed by the image processing software. Other processing is also possible.

Incorporation of camera 126 and array of transmitters 133 into the device provides an entirely new feature to the device. When the camera is pointed at an object, the real world objects 125 are captured as an image but the image can be modified by instructions 128 for processing of different parts of the image as provided by tags 113. The limits of what can be done with the captured images rest with the processing software and with the instructions provided by the tags (via the internet).

In providing means for testing different parts of an image to determine whether each portion of the image contains a tag, and what the information within the tag is, this embodiment provides a means by which certain properties can be assigned to certain parts of an image. The greater the number of individual footprints that can be correlated with the image, and the smaller each one is, the greater the resolution of the data to be associated with the image and the more useful the device.

Images captured by the camera part of the device and data regarding the location of tags in relation to objects whose image has been recorded may be superimposed to provide many useful effects. For example, if the tags have data describing locations on the internet from which instructions can be downloaded, the downloaded instructions can be applied to the image as appropriate and as permitted by the owner of the reader/camera. In the example illustrated by FIG. 11, three friends are photographed and several reader footprints are applied to the people and background. The tags on each of the persons respond with information including their ID and the ID of the reader footprint that has activated each of the tags. Each tag ID is used to download instructions from the internet about how each tag owner would like their image handled. The reader information from each tag is used to determine the location of each tag within the frame of the recorded picture. Given these two pieces of information, the device is able to assign each set of downloaded instructions to a particular part of the image recorded. In the illustration of FIG. 19, the downloaded instructions have been used by each tag-owner to assign text and/or images and effects to each of their bodies as they are represented in the picture. Image recognition and other forms of software that are able to pick out specific objects from a picture can assist with the application of downloaded instructions to the image. For example, in the illustration given in FIG. 19, one of the three friends has a halo effect applied to his head, and one would assume that this character does not wish this effect to be mistakenly applied to his feet or to an object not on his body. One example of a process for applying this effect to the correct place would be to include appropriate processing software/hardware and instructions such as “find large shape, preferably human . . . apply halo effect approximately 6” above head or top of human shape . . . if human shape is not found near tag, then simply apply halo above top of large object located nearest tag”. Image recognition software might be used to perform the required task of applying effects and processing in the correct part of an image.

In another embodiment, with reference to FIG. 8, the reader 110 consists of a preferably radio frequency omnidirectional transmitter 111, and an infrared camera 147 with ability to detect visible and infrared emissions. The tag, shown in FIG. 2, consists of an RF receiver 115 and an IR transmitter 111 as well as appropriate processor 149 and optional power cell 116. The tag responds to requests for identification by emitting an infrared signal that is detectable by the infrared camera from a distance equivalent to that at which a camera would typically be located relative to the object it is being used to photograph. The response may be encoded using any of many methods known to those skilled in the art, such as frequency modulation or pulsing.

Per FIG. 6, receiver 115 is, in this embodiment, an infrared camera 147, shown in FIG. 28. The IR software 150 monitors the infrared image captured by the camera, and locates tags based on typical IR signatures of responding tags. IR software 150 transfers the location of IR tags and the identification signal received from each to software 117, which translates the signal into machine-readable code. Software 150 and 117 may be integrated in such a way that they are the same program. The identity information is then provided to software for communicating with web site 121, which obtains instructions for image processing, 128. The instructions, 128 are then associated with information about the location of the tags 113 as determined by the IR software 150 and then provided to image processing software 127.

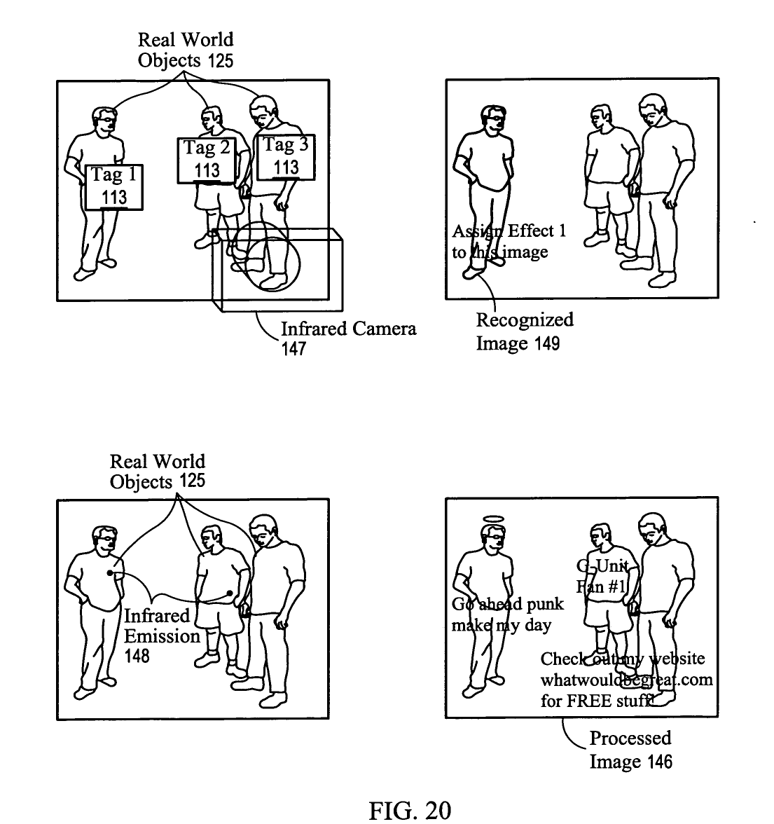

Image processing software 127 is also provided with the purely visible-light image captured by infrared enabled camera 147. The software 127 may be designed in such a manner that it recognizes objects within an image. As shown in FIG. 20, the infrared-determined map of the location of tags is then overlaid with the visible-light image data and thus, the image-processing software assigns each tag to the appropriate object. The software 127 may alternatively be designed in such a way that it assigns a tag not to a recognized image of an object, but to a section or area of the overall image captured by the camera.

This embodiment allows association of extra data with images captured using a camera capable of capturing visible and infrared images. Special effects may be performed on images using captured data about a real world object 125. While an infra-red camera may be used due to availability of infra-red cameras and the resolution afforded by said devices, any array of one or more directional receivers or any kind of camera or variation on a camera capable of detecting any kind of transmitted signal could be used in conjunction with a regular digital camera instead of the infra-red camera. In the case that visible light is used as the transmitted response, the array of directional receivers may be the camera itself.

In a further embodiment, video may be recorded and processed per FIGS. 11-20, 28. Instead of camera 126, a video recording device such as a video camera may be used. In one embodiment, although not required, image-processing software 127 includes a function that allows instructions 128 to be assigned once to a given tagged real-world object 125. Technology such as face tracking and other image tracking and recognition technologies may be used to maintain image effects on a non-stationary image once instructions for processing that image are assigned as described.

In this embodiment, real-time or recorded video can be processed using data from tags. Preferably, a real-world object 125 is followed on-screen in order to reduce the number of requests and responses required of the reader 110 and tag 113. Since multiple interrogations of the tag 113 by the reader, 110 would yield only redundant information, while still costing energy to emit infrared, RF or other radiation, this modification would increase the efficiency of the device for video image capture.

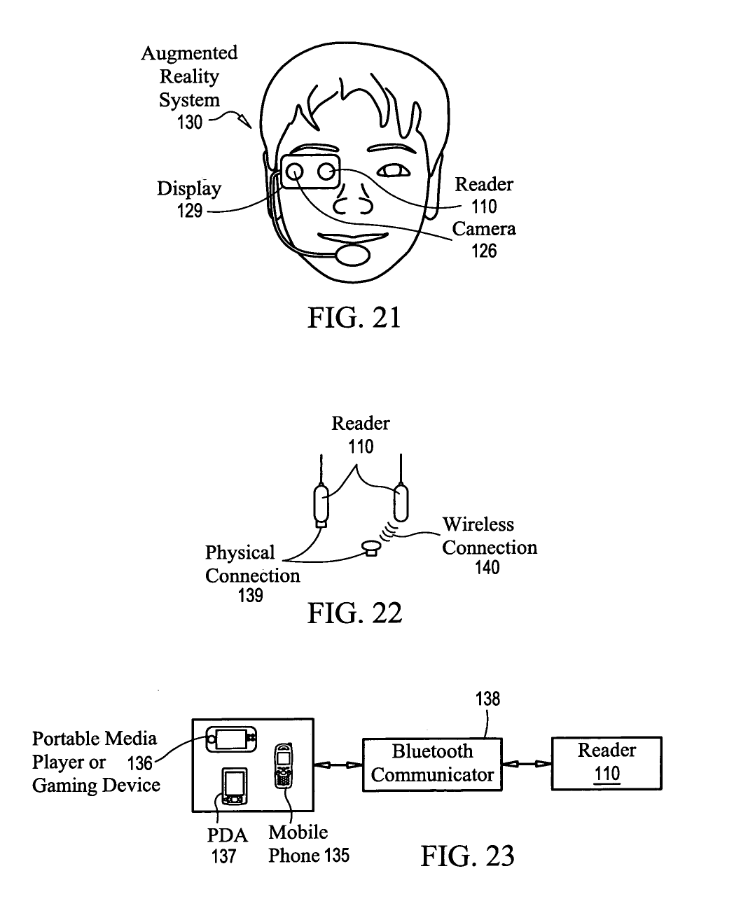

In another embodiment, shown in FIG. 21, the display 129, reader 110 and camera, 126 are incorporated into an augmented or virtual reality system. The display 129, in such systems can take many forms, from an LCD or other display to a method of projecting images directly onto the retina, via the tongue, directly into the nervous system and other methods. The reader may be attached to the augmented reality system or separate and able to communicate with the augmented reality system either directly or indirectly. The reader may be of any of the types described in any of the embodiments listed herein. The reader may scan the field of view of the user, either in a preprogrammed fashion, according to eye movements, manually as a handheld scanner, with head movement, as controlled by the user via the augmented reality system or directly or in another fashion.

In this embodiment, the processed images of real world objects can really represent the appearance of tag-owners to owners of augmented reality sets. Real experiences and data derived from tags and other sources can be integrated and experienced in real-time or associated such that later review of the experiences or data integrates the real and tag-derived data. When it becomes common for consumers to use augmented reality equipment, the use of tags will be almost exactly analogous to the wearing of fashionable clothes nowadays.

In still another embodiment, the display 118, is a storage medium such as a flash memory card or hard drive. Other device, such as media player or other device with display but no internet or network connection can be attached to storage medium in order to access files downloaded from internet by device.

In another embodiment, the tag is manufactured in such a way that it detects the requesting directional beam or omnidirectional signal emitted from the reader and harvests energy from the incoming signal for use in powering the transmitter associated with the tag. In this embodiment, the size and cost of tags can be substantially reduced by decreasing the energy storage requirements of a tag.

In a further embodiment, shown in FIG. 30, the reader 110 emits a directional beam containing the ID of the reader, the request for identification of the tag 113 and the time of the request. The tag is manufactured such that it responds with an omnidirectional signal containing the ID of the tag as well as the ID of the reader, and the time of the request as provided by the reader.

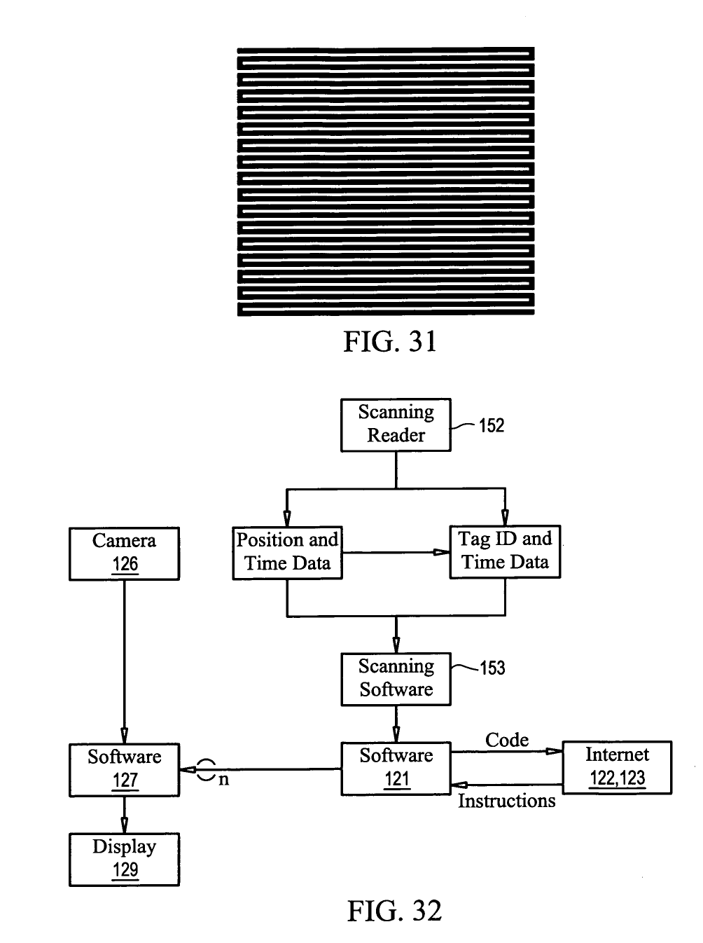

The reader is incorporated into a scanning reader 152 which is a device that scans the field of view of an attached camera 126 with the beam emitted from reader 110. One suggested path of the scanning beam is shown in FIG. 31. Turning attention now to FIG. 32, the position of the scanner at any given time is recorded. It is then synchronized with the time indicated by responses from tags 113 by scanning software 153. Scanning software 153 then provides the location and identity of tags in the field of view of camera 126 to software 121. Software 121 provides image-processing instructions 128 to image-processing software 127. Image-processing software 127 processes the images captured by camera, 126 and the processed images are displayed by display 129.

In this embodiment, a single reader 110 is incorporated into a scanning reader 152 that scans the field of view of a camera 126. Software matches the responses from tags 113 to the area being scanned by the scanning reader using time data. The resulting position data for tags is used to process an image captured by a camera 126.

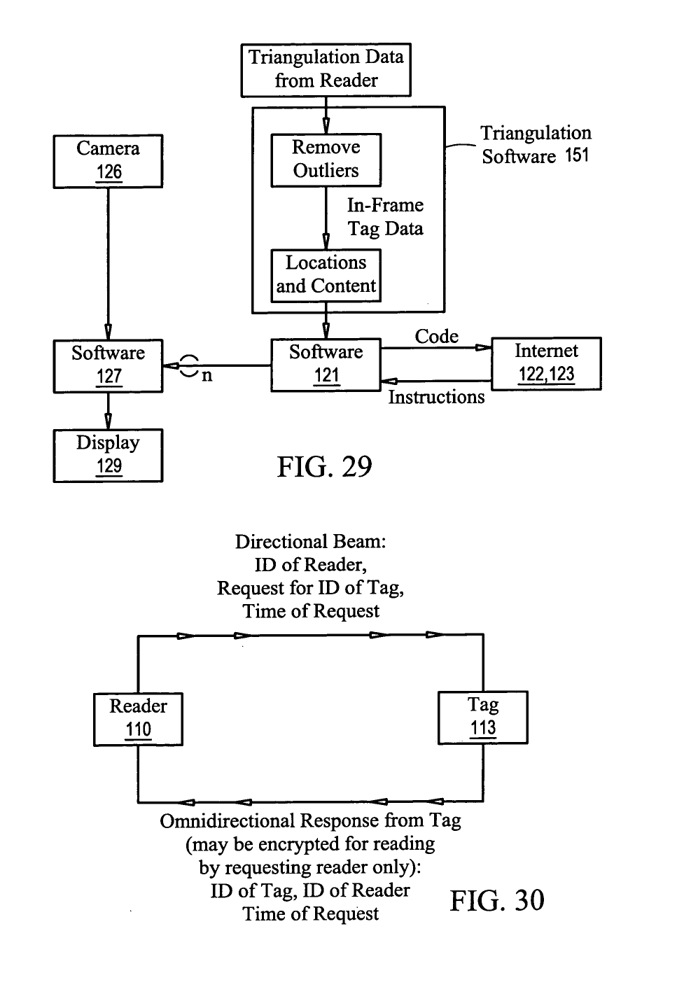

In a further embodiment, shown in FIG. 29, an RFID reader and RFID tags or other reader-tag system may be used. Triangulation is used to find the locations of tags relative to the reader. Triangulation software 151 removes the information about tags that are out of the field of view of the camera 126 and provides the remaining identification data from each tag to the software for communicating with websites 121. Via internet sites 122 and 123, instructions 128 are provided to the image processing software 127. The software processes images captured by camera 126 using instructions 128. The processed image is then displayed on display 129. This embodiment uses triangulation to determine the location of tags within the frame of the picture. The location data and image data are associated as previously described to add data to the image.

In yet another embodiment, two or more image-recording devices are used to obtain image data and either one or more readers capable of obtaining location data of the RFID tags. This embodiment is an application of the invention to a system where two or more images of the same scene are recorded from different angles to provide some kind of three-dimensional image or perspective.

In a further embodiment, reader 110, and tag 113, are combined in one unit. This embodiment provides the user with tag and reader in one unit, so that only one device need be carried around if the user wishes to use both.

In still another embodiment, the tag incorporates an on/off switch. This embodiment provides the user with a means by which he or she can avoid being identified when he or she wishes to do so.

In a further embodiment, the tag 112, contains two or more receptors for different methods of interrogation, for example, IR and RFID. This embodiment allows the tag to be interrogated by both an IR directional beam and an RFID non-directional beam, for example, thus improving functionality of the tag and not limiting it to interrogation by only one kind of device and in one circumstance.

In another embodiment, the tag 112, contains a GPS or other device that provides location data when the tag receives a request for identification. The reader also has one or more such devices incorporated. This embodiment allows the reader to transmit the request for identification and receive the response without regard for directionality of transmission. When interrogated, the tag emits its location coordinates, obtained from an integrated or attached GPS or other locating device. Software processes the location data to make it fit with image data and/or orientation or location data from the device.

In still another embodiment, the tag 113 is constructed in such a way that it does not immediately respond to a directional transmission from reader 110. The tag also contains an antenna capable of receiving RF and a system, common in RFID tags, for harvesting energy from the incoming RF signal and responding using RF. The transmission instructs the tag to respond to an RFID request that contains an appropriate reader identification, password or other means of limiting the readers that can access the tag. In this embodiment, the directional beam is used to grant access to the tag for a standard RFID reader. The beam instructs the tag about to which reader it should respond and the tag only will respond to interrogation by this reader. In this way, a simple directional beam capable of transmitting information required for granting access can be used in collaboration with a standard RFID reader to interrogate the tag.

In yet another embodiment shown in FIG. 22, reader 110 has a physical connector 139, which may be a USB connector or means of connecting to a range of portable devices. As illustrated, the reader 110 and physical connector 139 may be connected directly to each other or they may be connected via a wireless connection 140. In this embodiment, the reader may be attached to another device such as a handheld computing device. The reader serves to add the physical elements of the device. All processing of the tag identification is done by the attached device.

In still another embodiment, illustrated in FIG. 23, reader 110 is connected to a Bluetooth communicator 138. Bluetooth communicator, 138 may be password-encrypted and facilitates remote control and receipt of data from reader 110. In this embodiment, external devices such as mobile phone 135, portable media player or gaming device 136, and PDA 137 communicate with Bluetooth communicator 138 to activate and receive data from reader 110. Software on the particular external device used performs all other data processing functions.

In a further embodiment, not shown, the request-receiving part(s) of a tag may be connected wirelessly or physically or by other means to another device that performs other functions of the tag. In this embodiment, the receiver may be placed in a location that is well suited to receiving requests, and the other device(s) that serves the remaining tag functions may be located elsewhere. One example of this embodiment would have one or more infra-red receiver(s) of the tag located on the outside of a wearer's clothing, preferably in locations that are easily accessible to direct, line-of-sight communication of requests from the reader(s). In this example embodiment, the infra-red receivers may communicate all or selected infra-red signals received or only those identified as properly formatted requests to the remainder of the tag, which may be part of a mobile phone, PDA or other device located elsewhere on the user. The remainder of the tag may then communicate the response directly or indirectly to the reader(s).

This embodiment serves to overcome constraints of using infra-red, visible, and other line-of-sight means of requesting identification that cannot easily pass through opaque materials such as clothing. The use of an external receiver to the tag that communicates with the remaining functions at another location puts the receiver in the line of sight of a reader. The receiver communicates requests for identification or other information to a non-line-of-sight aspect of the tag by non-line-of-sight means such as radiofrequency or other means. The remainder of the tag may then respond using non-line-of-sight means to the reader, or direct the response through an external emitter.

In a further embodiment, not shown, the response-sending part of the tag may be connected wirelessly or physically or by other means to another device that performs other functions of the tag. In this embodiment, the responding transmitter may be placed in a location that is well suited to sending requests via line-of-sight transmission such as infra-red, visible or other means, and the other device(s) that serves the remaining tag functions may be located elsewhere. One example of this embodiment would have one or more infra-red transmitter(s) of the tag located on the outside of a wearer's clothing, preferably in locations that allow an infra-red or other detector that forms part of the reader to easily detect transmissions from the tag. The transmitter located separately from the remainder(s) of the tag may receive communications from the remainder(s) of the tag in the form of non-line-of-sight transmissions. In this case, the transmitter should include a receiver to receive said transmissions. The transmitter in this embodiment must also include means to translate into another means of communication such as infra-red, or boost the signal received from the remainder(s) of the tag.

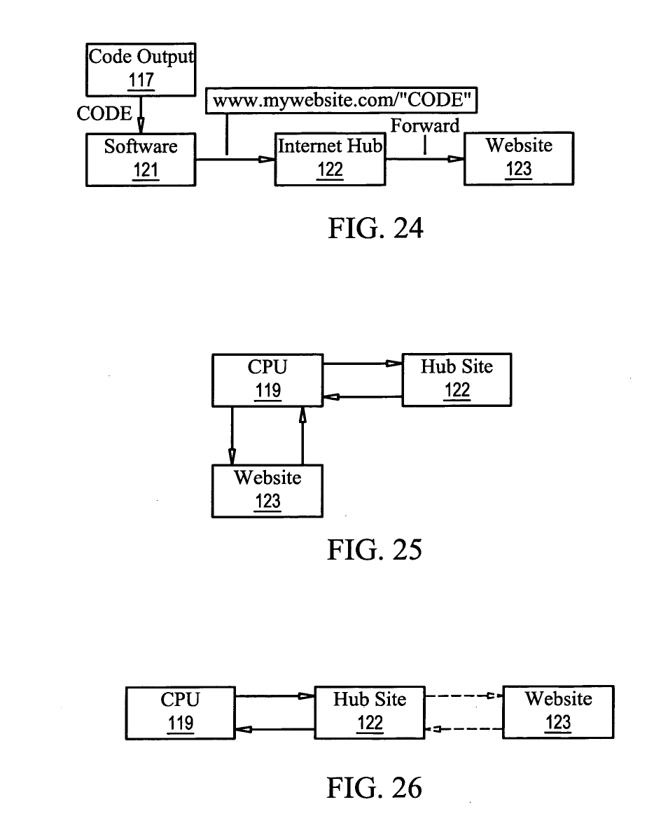

In a further embodiment, shown in FIG. 24 software, 121 uses the code output from processor 117 to direct a browser to visit a hub website 122. The URL of the website visited is composed of a prefix, for example, “http://www.mywebsite.com/” and a suffix that is determined by the code received by the software 121. The hub website 122 may optionally contain instructions to forward to another page, website 123. This embodiment provides a simple method of using the identity of the tag to locate a webpage.

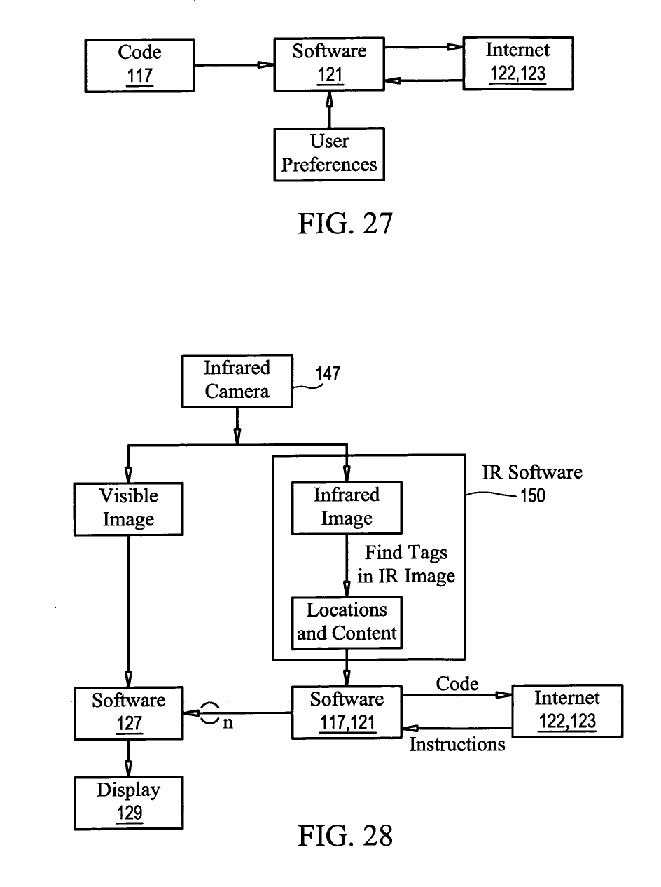

FIGS. 25 and 26 show additional methods of accessing particular websites 123 via a hub site 122. In FIG. 25, the hub site 122 provides the URL of a second site 123 to the CPU and the CPU then visits the URL provided. In FIG. 26, the hub site 122 displays second site 123 as part of hub site 122. Optionally, hub site 122 may translate or modify the information contained in second website 123 for display or particular use by the visitor. As illustrated in FIG. 27, the preferences of the user may be transmitted to hub site 122 or second website, 123 in order to allow the website to tailor its response to the particular user visiting. In this embodiment, additional methods of accessing particular websites are shown. Further, a method is described whereby the preferences of a visitor may be used to tailor the website visited to those preferences.

In another embodiment, the tag and reader are incorporated into a mobile phone or other device, or the mobile phone or device may perform the functions attributable to a tag or reader. In this embodiment, the identity of the tag may be associated with or identical to the identity of the phone as used in Bluetooth functions or it may be associated with or identical to the telephone number of the phone. In this embodiment, aside from producing a complete communications package, several additional improvements can be made. The association of the tag identity and the Bluetooth address of the phone makes it possible for all of the applications of Bluetooth to be made directional. The address of another user's phone could be obtained by pointing at that person, and afterwards, functions could be performed using Bluetooth such that the users need not maintain line-of-sight throughout. Association of the tag address with the telephone number of the user would allow users to call each other after first exchanging telephone numbers by line-of-sight. Information regarding the ID of the tag or reader, or other communications involved in obtaining information from the tag may be routed through a network or other intermediate devices instead of being directly transmitted from tag to reader or reader to tag.

In a still further embodiment, identification of an object may be made without use of tags. Means for accomplishing tag-free identification may include use of image databases and searching technology or other image-recognition technology. Where reasonably accurate image-recognition is possible, a recognized image may be correlated to an identification number as provided by tags 113 in other embodiments discussed herein. Image-processing instructions 128 and other information may be obtained from a hub site 122 or second site 123 using said identification number. Use of this method of obtaining image-processing instructions could be applied in combination with or without the use of tags and with any device described herein, including but not limited to a camera, video camera and augmented reality systems.

Accordingly the reader will see that, according to the invention, I have provided a description of a device that allows users to “wear” information of their choosing and allows passers-by and other nearby people to become visitors to their information store. This device is a new concept with many wide-ranging applications from social and business networking to advertising and beyond.

While the above description contains much specificity, these should not be construed as limitations on the scope of the invention, but as exemplifications of the presently preferred embodiments thereof. Many other ramifications and variations are possible within the teachings of the invention. For example, tags might be attached to inanimate or animate objects such as signs, buildings, vehicles as well as people. Tags might transmit processing or other additional information directly to the reader without the requirement that the reader download further instructions for image or other processing. In another example, since the invention is intended to convey information to the visitor, this can be displayed in a seemingly endless number of ways including visually, by audio, via the tongue, and via other senses, and also including subsets of these. For example, visual representation can include special effects, text, images, movies, graphs, cartoons, etc. Further, the visitor depending on his or her preferences could modify the representation in a number of ways. The invention could be incorporated with other existing or not-yet-existing devices such as media players, gaming devices, mobile phones, etc, and according to the size and requirements of the additional devices, different types of controls, etc, can be incorporated.

Further variations include the use of other tagging and reading systems means, such as Bluetooth, infrared, visible, ultraviolet, RFID and other systems. Different wavelengths of electromagnetic radiation may be used also, for example, infrared, ultraviolet, radiofrequency, microwave, visible, and higher and lower wavelengths than those mentioned. Additionally, other methods of information transmission such as sound could be used. Devices could be encrypted or unencrypted using differing methods. Tags and readers can be incorporated into other devices or other devices can be made to function in a manner that simulates tags or readers. Both tags and readers may be comprised of multiple parts that work together. Further, these parts may each be incorporated as parts or functions of other devices. In addition, data can be transmitted via intermediates such as communication networks and other additional steps can be included. Data collected could be stored or used in real time. The invention or attached device could incorporate information about itself into the request it sends for the web page, thus altering its appearance accordingly. The tag could be made to provide more information than just its identity for use in locating a specific web or network address. It could also be made to provide information about its identity or other relevant information without being requested to do so-perhaps continuously or in a regular or irregular fashion based on time, location, etc.

Further, the exact effect of data obtained from the tag via the internet on the output or display depends to a great extent upon the programming of the device, which may be, to a large extent dependent upon the users wants, requirements and previous downloaded or otherwise installed software.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. An interactive networking system, comprising:
one or more readers able to communicate with a network, wherein the network includes information accessible at a network location; and
one or more tags containing the network location of the information, wherein, upon receipt of an interrogation signal from one of the one or more readers, a tag is able to communicate the network location to the interrogating reader thus making the information accessible to the interrogating reader.

2. The system according to claim 1, wherein one or more readers further comprises:
a display for displaying the information;
a data storage device for storing information received from the tag; and
a processor.

3. The system according to claim 1, wherein one or more readers further comprises a camera.

4. The system according to claim 3, wherein the camera is able to capture an image, and wherein the processor is able to associate at least a portion of the information with the image.

5. The system according to claim 1, wherein the one or more tags and the one or more readers are able to communicate with each other, at least a portion of the communication using infra-red transmission.

6. The system according to claim 1, wherein the one or more tags and the one or more readers are able to communicate with each other, at least a portion of the communication using radiofrequency transmission.

7. The system according to claim 1, wherein at least one reader and/or at least one tag further includes directional communication elements.

8. The system according to claim 7, wherein an interrogating reader transmits a reader identification signal to a destination tag such that the destination tag may determine the identity of the interrogating reader among multiple readers.

9. The system according to claim 1, further comprising an intermediary communication network whereby communication signals between a reader and a tag travel at least partially through the intermediary communication network.

10. The system according to claim 1, further comprising an intermediary device in communication with the one or more readers and the one or more tags, the intermediary device having signal-receiving capabilities for receiving the interrogation signal from the one or more readers and signal-transmitting capabilities for transmitting the interrogation signal to the one or more tags.

11. The system according to claim 1, further comprising an intermediary device in communication with the one or more readers and the one or more tags, the intermediary device having signal-receiving capabilities for receiving a signal from the one or more tags, the signal representing the network location, and signal-transmitting capabilities for transmitting the signal to the interrogating reader.

12. A method of conveying information, the method comprising:
providing a tag, wherein the tag includes information;
providing a reader, wherein the reader is able to transmit communication signals to the tag, the communication signals including a request for the information;
upon receipt of the request for information, communicating the information from the tag to the reader; and
accessing the information with the reader.

13. The method according to claim 12, wherein the information includes a location on a network where additional information can be found.

14. The method according to claim 12, wherein the tag may be selectively disabled from communicating with the reader.

15. The method according to claim 13, wherein the network is the Internet.

16. The method according to claim 12, wherein the reader includes a reader identification, and wherein the request for information includes communicating the reader identification from the reader to the tag.

17. The method according to claim 12, further comprising displaying the information.

18. A method of associating one or more images with corresponding information in a network, the method comprising:
identifying one or more images;
identifying information relating to the one or more images, the information available on the network;
providing processing instructions; and
associating the information with the one or more images according to the processing instructions.

19. The method according to claim 18, wherein associating the information with the identified images includes superimposing indicia on the one or more images.

20. The method according to claim 18, wherein associating the information with the identified images includes associating one or more audio files with the one or more images.

21. The method according to claim 18, further comprising providing one or more readers, the one or more readers including means for capturing the one or more images.

22. The method according to claim 21, further providing one or more tags, wherein at least one tag includes the processing instructions.

23. The method according to claim 21, further comprising providing one or more tags, wherein at least one tag includes a network resource location where the processing instructions are located.

24. The method according to claim 21, wherein the processing instructions are available at a network resource location on the network.

25. A tag for use in an interactive networking system, the interactive networking system including one or more readers in electronic communication with the tag, the tag including:
means for receiving communication signals from a requesting reader, the communication signals including a request to the tag for information related to the tag; and
means for making at least a portion of the information accessible to the requesting reader.

26. The tag according to claim 25, wherein the means for making at least a portion of the information accessible to the reader includes a signal from the tag to the reader, the signal containing a network location identifier, the network location identifier indicating the location in the networking system where at least a portion of the information resides.

27. An interactive networking system, comprising:
one or more readers able to communicate with a network, wherein the one or more readers include at least one directional reading element; and
one or more tags able to communicate with the one or more readers, the one or more tags containing information, wherein upon receipt of an interrogation signal from at least one directional reading element, the tag makes the information accessible to the interrogating reading elements.

28. The system according to claim 27, wherein the reading elements comprise a combination of directional and non-directional reading elements.

29. The system according to claim 27, wherein the interrogation signal includes reader transmission information, the reader transmission information including at least one of a relative direction of the interrogation signal, a time of emission of the interrogation signal, location of an area targeted by the interrogation signal and identification information relating to the reading element emitting the interrogation signal.

30. The system according to claim 29, wherein upon receipt of the interrogation signal, the one or more tags provide a responsive signal including at least a portion of the reader transmission information.

31. The system according to claim 30, wherein the responsive signal further includes identification information relating to the interrogated tag.
